(19) United States
(12) Patent Application Publication
(10) Pub. No.: US 2026/0052243 A1
(43) Pub. Date: Feb. 19, 2026

(54) TEMPORAL INTRA MODE DERIVATION

(71) Applicant: INTERDIGITAL CE PATENT HOLDINGS, SAS, Paris (FR)

(72) Inventors: Franck GALPIN, Thorigne-Fouillard (FR); Thierry DUMAS, Rennes (FR); Karam NASER, Mouazé (FR); Kevin REUZE, Rennes (FR)

(21) Appl. No.: 18/853,577

(22) PCT Filed: Mar. 22, 2023
(86) PCT No.: PCT/EP2023/057362

§ 371 Date: Oct. 2, 2024

(30) Foreign Application Priority Data
Apr. 7, 2022 (EP) 22305472.7

(51) Int. Cl. H04N 19/11; H04N 19/176; H04N 19/593

(52) U.S. Cl. CPC H04N 19/11; H04N 19/176; H04N 19/593

(57) ABSTRACT

Intra prediction modes are derived in video encoders and decoders using one of several embodiments. In at least one embodiment, an intra prediction mode is derived when little or no spatial information is available. In another embodiment, motion information is extracted and a corresponding block is obtained from a displaced collocated block which is used to determine an intra prediction mode for encoding/decoding a video block or sub-block. In another embodiment, a global motion model is computed at an encoder and sent in a slice header or a picture header to a corresponding decoder. In at least one embodiment, a different reference is used for a reference frame. In at least one embodiment, an index is signaled to indicate the intra mode, reference frame, or motion model is used for prediction.

### CROSS-REFERENCE TO RELATED APPLICATIONS

This application claims the benefit of European Application Serial No. 22305472.7, filed Apr. 7, 2022, which is incorporated by reference herein in its entirety.

### FIELD OF THE INVENTION

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY OF THE INVENTION

At least one of the present embodiments generally relates to a method or an apparatus for video encoding or decoding, and more particularly, to a method or an apparatus for improving the coding efficiency of decoder side intra mode derivation from surrounding reference pixels.

According to a first aspect, there is provided a method. The method comprises steps for determining a motion vector pointing to a reference frame for a video block; deriving a displaced collocated block from the motion vector; determining intra mode information from the displaced collocated block; conditionally adding the intra mode information to a most probable mode list; and encoding at least a portion of the video block using the most probable mode list.

According to a second aspect, there is provided another method. The method comprises steps for determining a motion vector pointing to a reference frame for a video block; deriving a displaced collocated block from the motion vector; determining intra mode information from the displaced collocated block; conditionally adding the intra mode information to a most probable mode list; and decoding at least a portion of the video block using the most probable mode list.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates the 67 intra prediction modes in VVC and ECM.

FIG. 2 illustrates derivation of generic most probable mode list for luminance for an intra slice in ECM.

FIG. 3 illustrates an example of signaling of intra mode FIG. 4 illustrates an example of matrix based intra prediction.

FIG. 5 illustrates the SbTMVP process in VVC.

FIG. 6 illustrates an example of template matching performed on a search area around initial MV.

FIG. 7 illustrates an example of template and reference samples of a template in reference pictures.

FIG. 8 illustrates template and reference samples for block and sub-block motion using the motion information of sub-blocks within a block.

FIG. 9 illustrates one embodiment of the proposed process workflow.

FIG. 10 illustrates an example of using a top-left sub-block to extract an intra mode.

FIG. 11 illustrates a multimode block.

FIG. 12 illustrates an example of template-based mode inference.

FIG. 13 illustrates three embodiments for collocated frame types using TIMD.

FIG. 14 a generic video encoding or compression system.

FIG. 15 a generic video decoding or decompression system.

FIG. 16 illustrates a processor-based system for implementing the described aspects.

FIG. 17 illustrates one embodiment of a method for performing the described aspects.

FIG. 18 illustrates another embodiment of a method for performing the described aspects.

FIG. 19 illustrates one embodiment of an apparatus for implementing the described aspects.

### DETAILED DESCRIPTION

The intra prediction is a fundamental coding tool in hybrid video coding. For a given block to be predicted, the encoder selects the best intra prediction mode in terms of rate-distortion and signals its index to the decoder so that, for this block, the decoder can perform the same prediction. Signaling the mode index can add extra overhead and reduce the gain from the intra part. Therefore, a smart way of coding the index of the intra prediction mode selected to predict a given block is to create a set of Most Probable Modes (MPMs) and thus reduce the signaling overhead if the index of the selected mode belongs to that list. This is a classical method for signaling the intra prediction mode index, known as MPM list-based signaling, which is employed in VVC and HEVC. This method is extended in ECM, where two MPM lists are used instead of one. From now on, when talking about MPM list-based signaling, for conciseness, the signaling of a mode index will be shortened to the signaling of a mode.

In ECM, two additional intra prediction modes are introduced. The first is known as Decoder-side Intra Mode Derivation (DIMD) and the second is known as Template-based Intra Mode Derivation (TIMD). In both modes, the reconstructed pixels surrounding the current block on the top and left directions (template pixels) are used to derive the intra prediction modes. Specifically, in DIMD, the template of reconstructed pixels is analyzed to deduce the directionalities of the template, from which two directional modes are selected. The prediction signal is generated by blending those two modes with the planar mode. In TIMD, on the other hand, several intra prediction modes are tested on the template of reconstructed pixels, and the two best modes are selected (those which minimize the Sum of Absolute Transform Difference (SATD) between the template of reconstructed pixels and its prediction). The prediction signal is generated by either applying the best mode or blending those two modes, depending on their prediction SATDs.

In inter coding, mode information can be predicted not only spatially (from neighboring blocks) but also temporally by getting information from a collocated frame. For example, SbTMVP (aka ATMVP) uses displaced collocated block motion information as a motion predictor.

### Core 67 Intra Prediction Modes

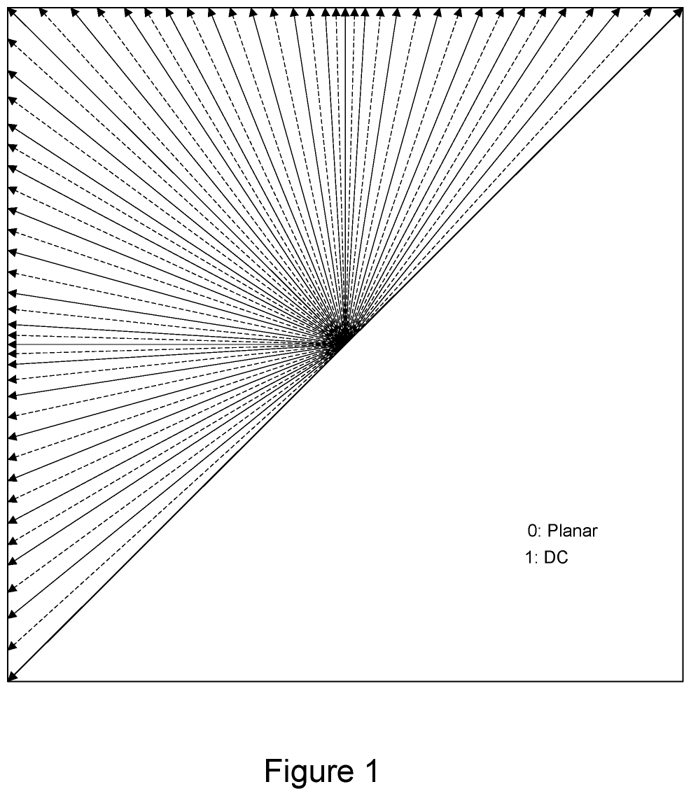

To capture the arbitrary edge directions presented in natural video, the number of directional intra modes in VVC is extended from 33, as used in HEVC, to 65. The new directional modes not in HEVC are depicted as red dotted arrows in FIG. 1. These denser directional intra prediction modes apply for all block sizes and for both luma and chroma intra predictions. In VVC, several conventional angular intra prediction modes are adaptively replaced with wide-angle intra prediction modes for the non-square blocks.

From HEVC to VVC, the planar and DC modes remain unchanged, excluding the following minor modification. In HEVC, every intra-coded block has a square shape and the length of each of its side is a power of 2. Thus, no division operations are required to generate an intra-predictor using the DC mode. In VVC, blocks can have a rectangular shape that necessitates the use of a division operation per block in the general case. To avoid division operations for DC prediction, only the longer side is used to compute the average for non-square blocks.

In ECM, the core structure of the 67 intra prediction modes is inherited from that in VVC. This core structure is refined in ECM:
the four-tap interpolation for a directional intra prediction mode becomes a six-tap interpolation.
Position Dependent Intra Prediction Combination (PDPC) is supplemented with gradient PDPC.

### MPM List-Based Signaling

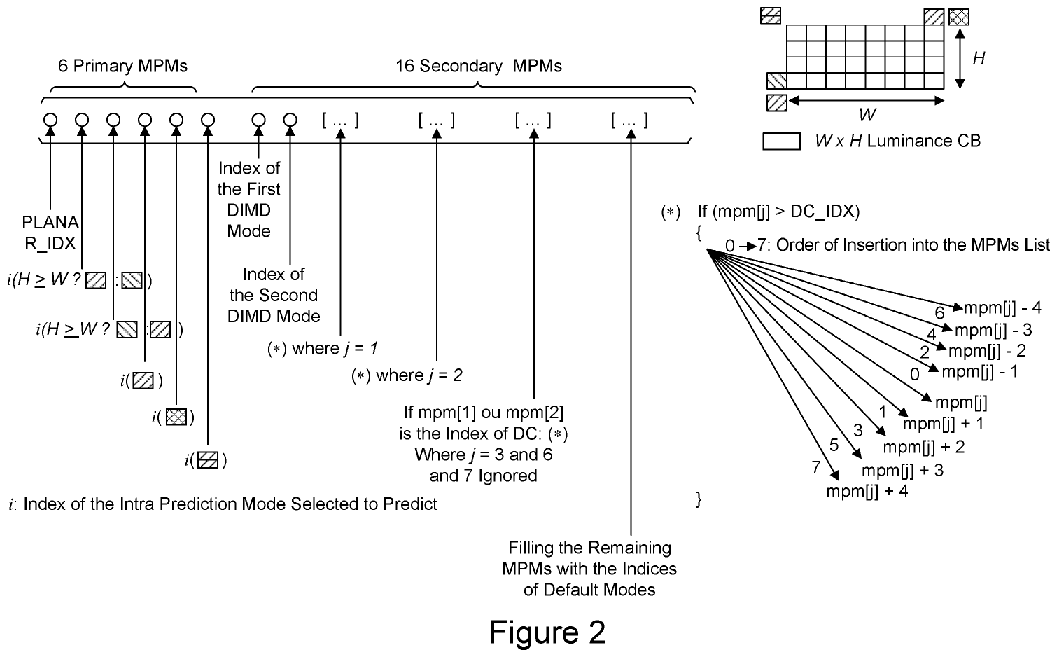

In ECM, if the intra prediction mode selected to predict the current luminance Coding Block (CB) is neither a Matrix-based Intra Prediction (MIP) mode, nor DIMD, nor TIMD, i.e. it is one of the 67 intra prediction modes mentioned in an earlier section, its index is signaled using the MPM list of this CB. In ECM, the generic MPM list is decomposed into a list of 6 primary MPMs and a list of 22 secondary MPMs, see FIG. 2. The generic MPM list is built by sequentially adding candidate intra prediction mode indices, from the one most likely being the selected intra prediction mode for predicting the current luminance CB to the least likely one. FIG. 2 shows, from left to right, the sequential addition of the candidate intra prediction mode indices in the case where the current luminance CB belongs to an intra slice. Note that no redundancy exists in the generic list of MPMs, meaning that it cannot contain two identical intra prediction mode indices. For readability, FIG. 2 illustrates the case where each candidate intra prediction mode index is different from one another. But, in the generic case, let us say the slots of indices 0 to i−1 included in the generic list of MPMs have already been filled. If the current candidate intra prediction mode index already exists in the current generic list of MPMs, this candidate is skipped, and the next candidate intra prediction mode will be inserted at the slot of index i if it does not exist in the generic list of MPMs. Otherwise, the current intra prediction mode index is inserted at the slot of index i and the next candidate intra prediction mode will be inserted at the slot of index i+1 if it does not exist in the generic list of MPMs.

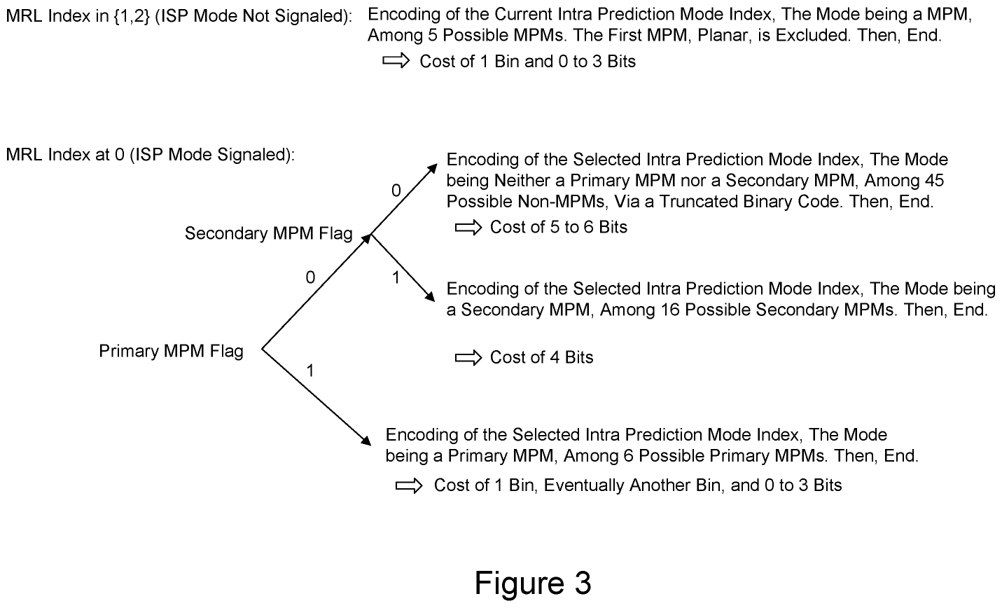

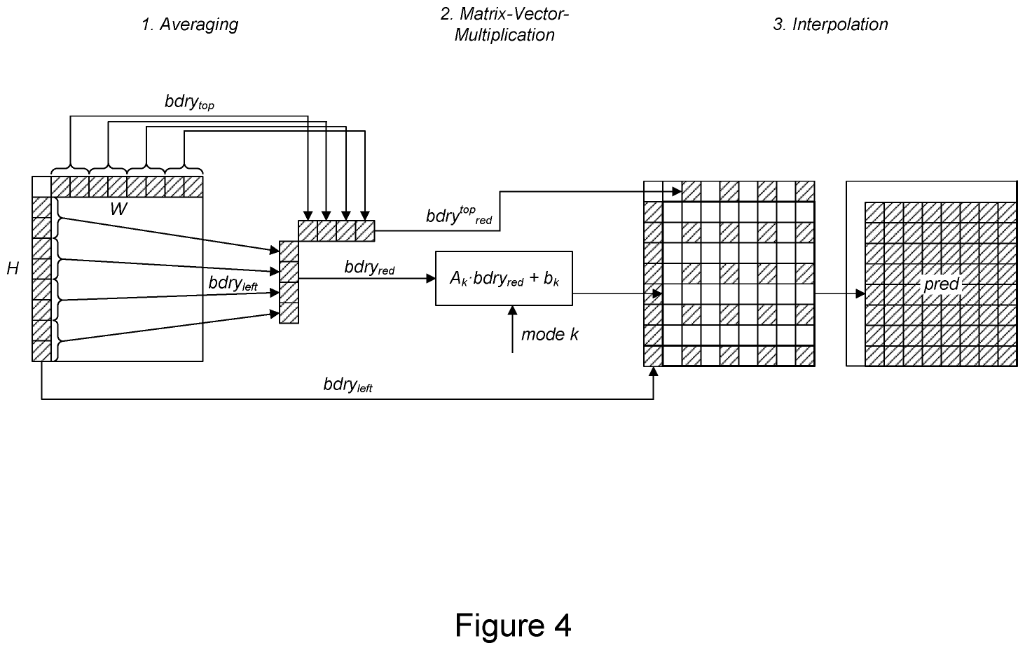

For the current luminance CB, if the selected intra prediction mode is neither DIMD nor MIP nor TIMD, after signaling the Multiple Reference Line (MRL) index and signaling the Intra Sub-Partition (ISP) mode if needed, the MPM list-based signaling of the selected intra prediction mode can be summarized via FIG. 3. FIG. 3 reveals that the MPM list-based signaling in ECM implements a hierarchical entropy coding of the index of the intra prediction mode selected to predict the current luminance CB.

### Matrix-Based Intra Prediction (MIP)

Matrix-based Intra Prediction (MIP) method is a newly added intra prediction technique to VVC. For predicting the samples of a rectangular block of width W and height H, MIP takes one column of H reconstructed neighboring boundary samples on the left side of the current block and one line of W reconstructed neighboring boundary samples above the current block as input. If the reconstructed samples are unavailable, they are generated as done in the conventional intra prediction. The generation of the prediction signal is based on the following three steps: optional averaging of the reconstructed neighboring boundary samples, matrix vector multiplication between a MIP weight matrix and the averaged neighboring boundary samples, and optional linear interpolation of the result from the previous multiplication, as shown in FIG. 4.

In ECM, up to ECM-4.0, MIP has not been modified with respect to its implementation in VVC.

### Decoder Side Intra Mode Derivation (DIMD)

For a given luminance CB to be predicted, DIMD derives two intra prediction modes from the template of reconstructed neighboring samples surrounding this CB, and those two predictors are combined with the planar mode predictor using the weights derived from the gradients in this template, as described in JVET-O0449. The division operations in weight derivation are performed utilizing the same lookup table (LUT) based integerization scheme used by the Cross Component Linear Model (CCLM). For example, the division operation in the orientation calculation

$$Orient = {G}_{y} / {G}_{x}$$

is computed by the following LUT-based scheme:

x = Floor( Log2( Gx ) )
normDiff = ( ( Gx << 4 ) >> x ) & 15
x += ( 3 + ( normDiff != 0 ) ? 1 : 0 )
Orient = (Gy* ( DivSigTable[ normDiff ] | 8 ) + ( 1 << ( x−1 ) )) >> x
where
DivSigTable[16] = { 0, 7, 6, 5 ,5, 4, 4, 3, 3, 2, 2, 1, 1, 1, 1, 0 }.

The two derived intra modes are included into the primary list of MPMs. Consequently, for a given luminance CB to be predicted, the DIMD process is performed before creating the MPM list. For a given luminance CB, the primary derived intra mode via DIMD is stored, and it is used for the MPM list construction of the neighboring luminance CBs.

### Fusion for Template-Based Intra Mode Derivation (TIMD)

For the current luminance CB, for each intra prediction mode in its MPM list supplemented with default modes, the SATD between the prediction of the template of this CB via this mode and the reconstructed samples of the template is calculated. The two intra prediction modes with the minimum SATDs are selected as the TIMD modes. Note that, for TIMD, the set of directional intra prediction mode is extended from 65 to 129, by inserting a direction between each black arrow and its neighboring red arrow in FIG. 1. This means that the set of possible intra prediction modes derived via TIMD gathers 131 modes. After retaining two intra prediction modes from the first pass of tests involving the MPM list supplemented with default modes, for each of these two modes, if this mode is neither PLANAR nor DC, TIMD also tests in terms of prediction SATD its two closest extended directional intra prediction modes. The two TIMD modes resulting from the two passes of tests are fused with the weights after applying PDPC, and such weighted intra prediction is used to code the current luminance CB. Note that PDPC is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only mode1 is used. Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

### Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

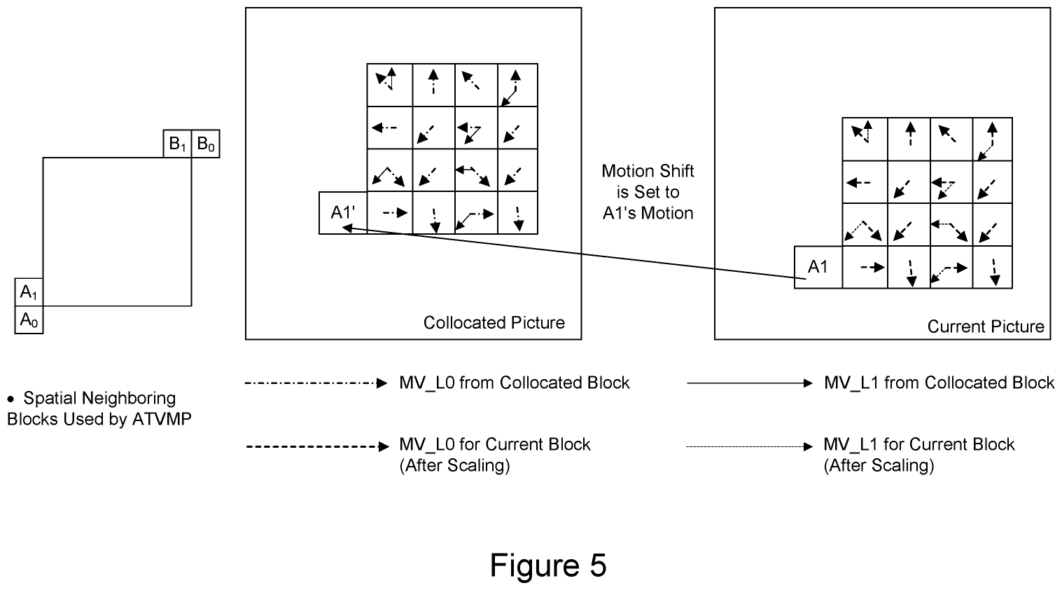

The SbTVMP process is illustrated in FIG. 5. SbTMVP predicts the motion vectors of the sub-CUs within the current CU in two steps. In the first step, the spatial neighbor A1 in FIG. 5(a) is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 5(b). The example in FIG. 5(b) assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height larger than or equal to 8.

The encoding logic of the additional SbTMVP merge candidate is the same as for the other merge candidates, that is, for each CU in P or B slice, an additional RD check is performed to decide whether to use the SbTMVP candidate.

### Template Matching (TM)

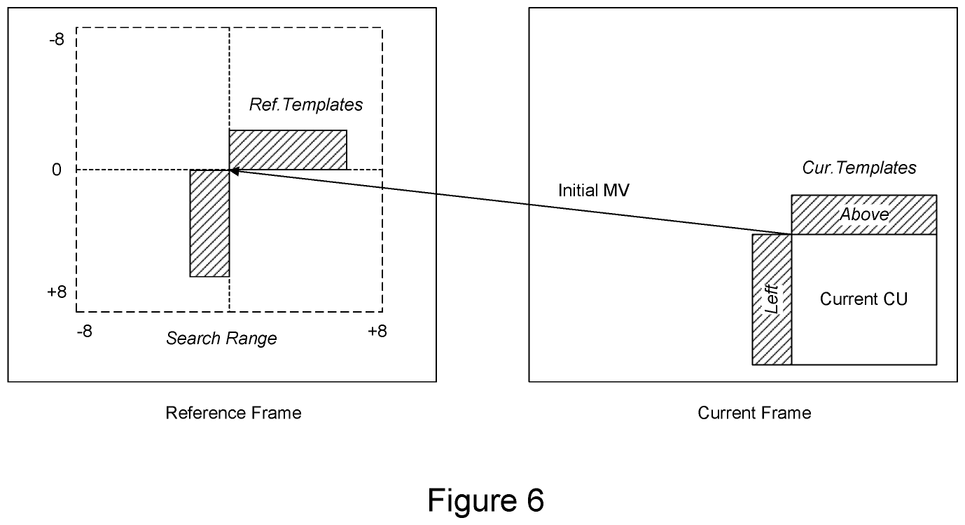

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 6, a better MV is searched around the initial motion of the current CU within a [−8, +8]-pel search range. The template matching method in JVET-J0021 is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 1
search patterns of AMVR and merge mode with AMVR.

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

Adaptive reordering of merge candidates with template matching (ARMC-TM) The merge candidates are adaptively reordered with template matching (TM). The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

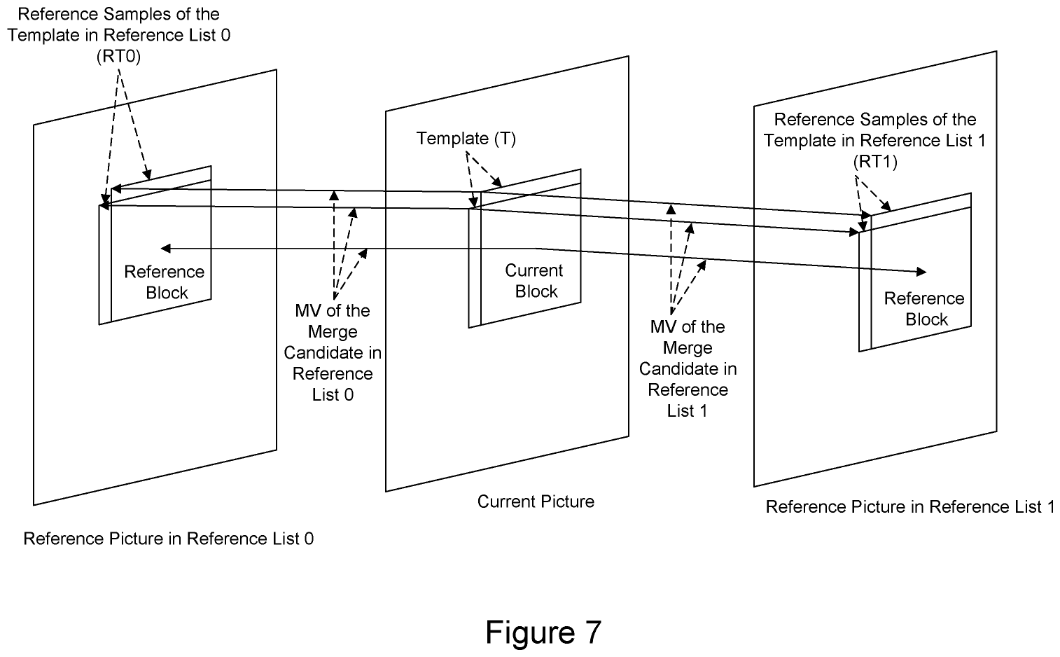

When a merge candidate utilizes bi-directional prediction, the reference samples of the template of the merge candidate are also generated by bi-prediction as shown in FIG. 7.

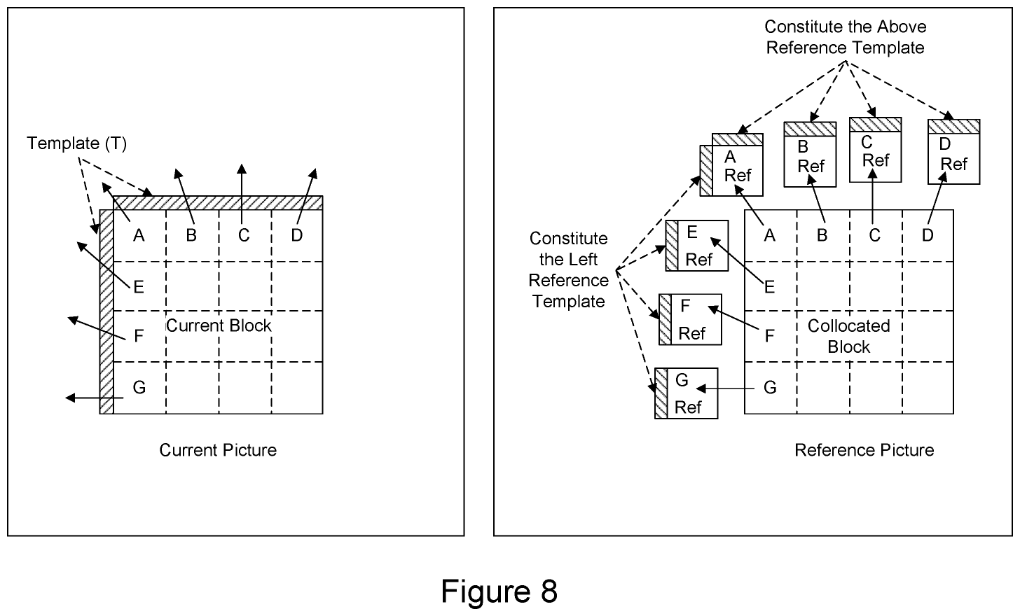

For subblock-based merge candidates with subblock size equal to Wsub×Hsub, the above template comprises several sub-templates with the size of Wsub×1, and the left template comprises several sub-templates with the size of 1×Hsub. As shown in FIG. 8, the motion information of the subblocks in the first row and the first column of current block is used to derive the reference samples of each sub-template.

### Proposed Embodiments

### Temporal Intra Mode Derivation

To improve the intra mode derivation when no/few spatial information is available, we propose a new temporal derivation mode.

This new mode can be added either as a new candidate, similarly to DIMD, TIMD or MIP candidates, or fill as a candidate in the MPM list.

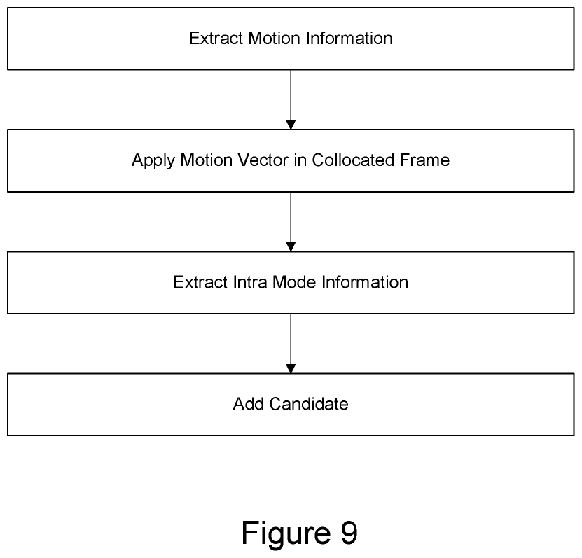

The derivation of the candidate is done as follows, see FIG. 9.
For the current block a motion vector pointing to the collocated frame is derived
The displaced collocated block is derived from this motion vector
Intra mode derivation is performed
Candidate is added

### Motion Vector Derivation

### Global Motion Model

As the first B-frame (after the initial I-frame) contains more intra coded block and fewer motion information, a global motion information is sent at the slice level. Typically, at least one global motion model is computed at encoder and sent in the slice header (or another header, such as a picture header).

Typical methods to compute a global motion are:
Perform a block matching between the reference frame and the current frame and extract the dominant motion
Extract salient points (for example Harris corners or SIFT points) and match them robustly according to a common motion model (for example using the RANSAC)

The motion model can be an affine 4, affine 6 or homographic model for example. Alternatively, several models can be transmitted. Advantageously, the model parameters can be sent as the motion of the corner of the frame, coded differentially:
Top-left corner sent as a motion vector using mvd encoding of the codec
Top-right corner: send the mvd of the difference between the motion of the top-right and the motion of the top-left already decoded
Bottom-left: same as top-right
Bottom-right: mvd of the difference between the bottom-right motion and the average of the top-left and bottom-left motion vector

From the global motion model, the motion of the current block is computed, for example using the motion of the center of the block. Alternatively, top-left or other location can be used to compute the motion of the block.

In case several models are available, an index of the model to use is signaled for the block using this mode. Advantageously, a context-based coding using neighboring block (typically top and left blocks) can be used to reduce the cost of signaling the index.

### Variant on Motion Derivation

Another way to get the motion information is to use the same process as the one used in inter coded blocks to deduce the motion. Typically, a list of probable motion vector candidates is computed, using a process similar to the merge inter list creation for example. The first candidate of the list is then used to infer the motion of the current block.

Alternatively, an index of the candidate to use to infer the motion is sent.

Alternatively, a template-based re-ordering similar to ARMC-TM is used to select the most probable candidate in the list.

### Variant on the Collocated Frame

In a variant, the collocated frame used as a reference frame for the motion vector is signaled in the slice header. Alternatively, the index is signaled at block level, the same way reference frame index is signaled in inter coded blocks.

### Intra Mode Derivation for Intra Slice Collocated Frame

If the reference frame is a I-frame, the intra mode used by the displaced block is directly available inside the blocks. Similarly, to SbTMVP, a block can contain several different intra mode.

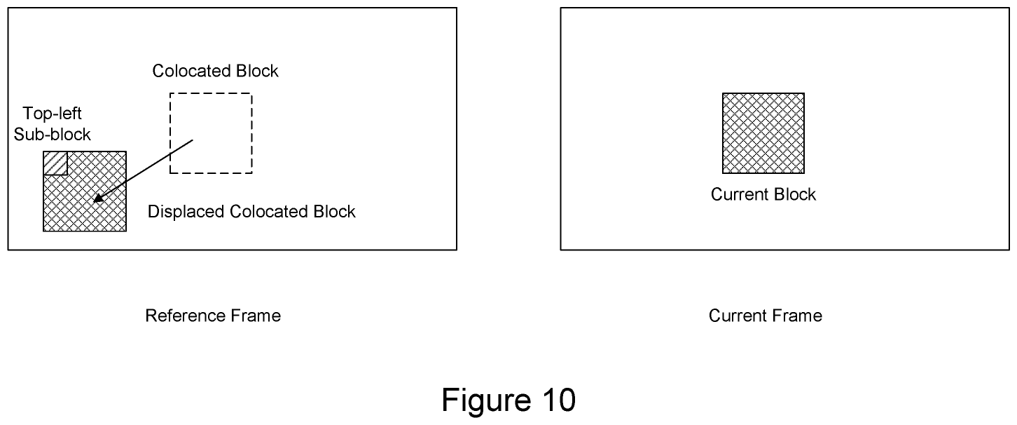

The final intra mode can be taken for example as the intra mode of the top left sub-block of the displaced block (see FIG. 10).

Alternatively, the center sub-block or any other block is used.

Alternatively, the most common mode inside the block is used.

### Variant: Multi Candidates

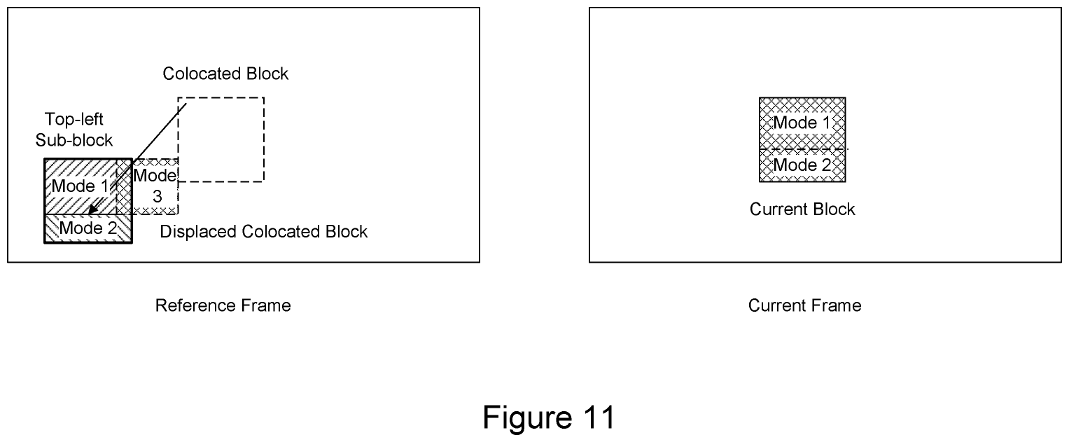

In a variant (see FIG. 11), when several intra modes are available in the block, a partitioning of the current block is inferred from the modes available in the displaced block. In the figure, 3 different modes are available in the displaced block. As the mode 1 would have a size non power of 2, the mode 1 is extended up to the next power of 2 size, removing the mode 3 part of the block. The block is then decoded using the independent intra mode and corresponding TU is mapped on the resulting partition.

### Intra Mode Derivation for any Collocated Frame Type

In a variant, the intra mode for the displaced block is inferred using a process similar to TIMD.

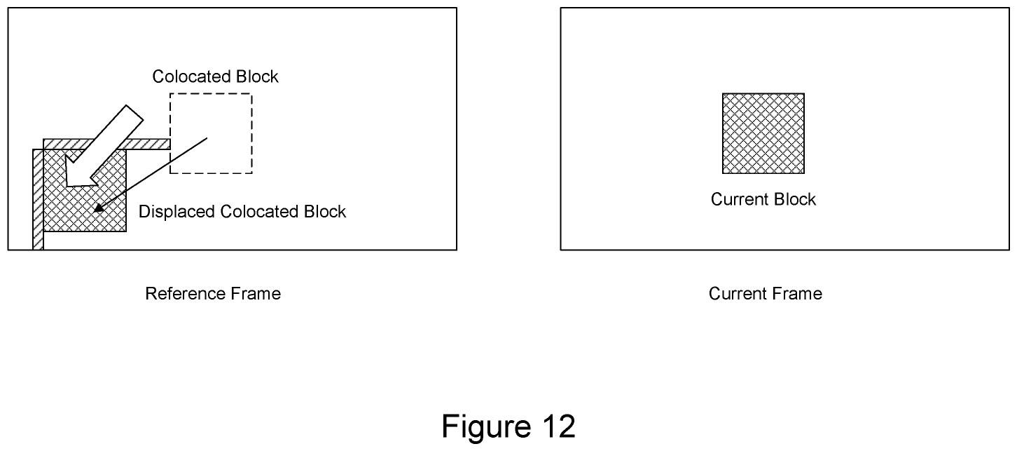

However, contrarily to TIMD where only the causal samples around the current block are available to test a particular mode fit, the samples of the whole block as well as the reference samples used during the default intra prediction process are available (see FIG. 12).

In this configuration, the process is as follow:
reference samples for the mode are extracted. Note that reference samples availability should be consider as the intersection of the reference samples availability in the current block and the reference samples availability at the displaced block location.
The intra mode is applied, creating a prediction for the displaced block
The error is computed between the created prediction and the displaced block reconstructed.
The same process as TIMD is used to rank and infer the intra modes

Note that contrary to traditional TIMD, all intra modes such as MIP mode can also be tested and ranked with other modes.

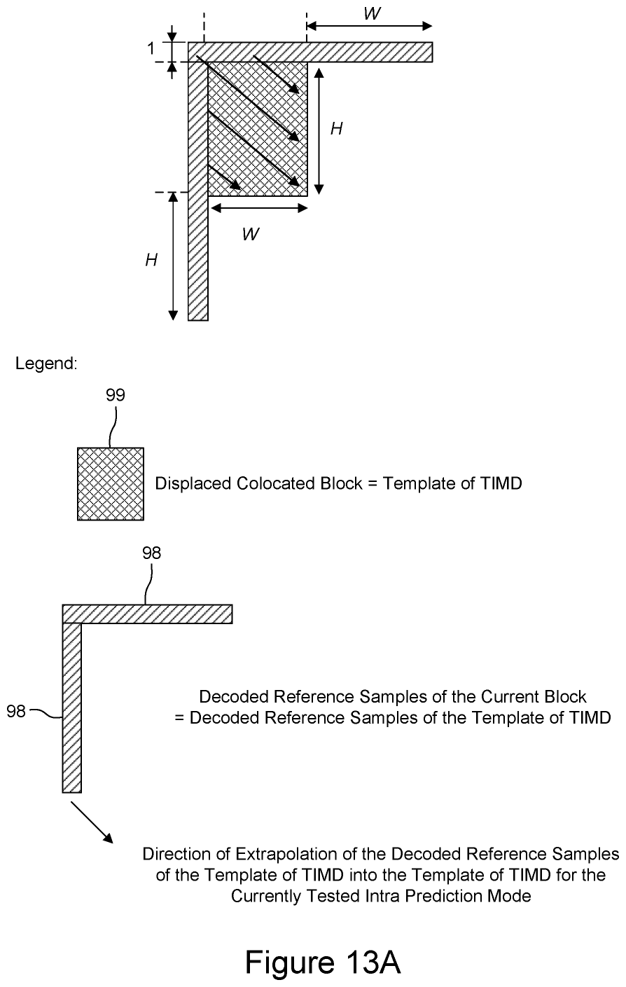

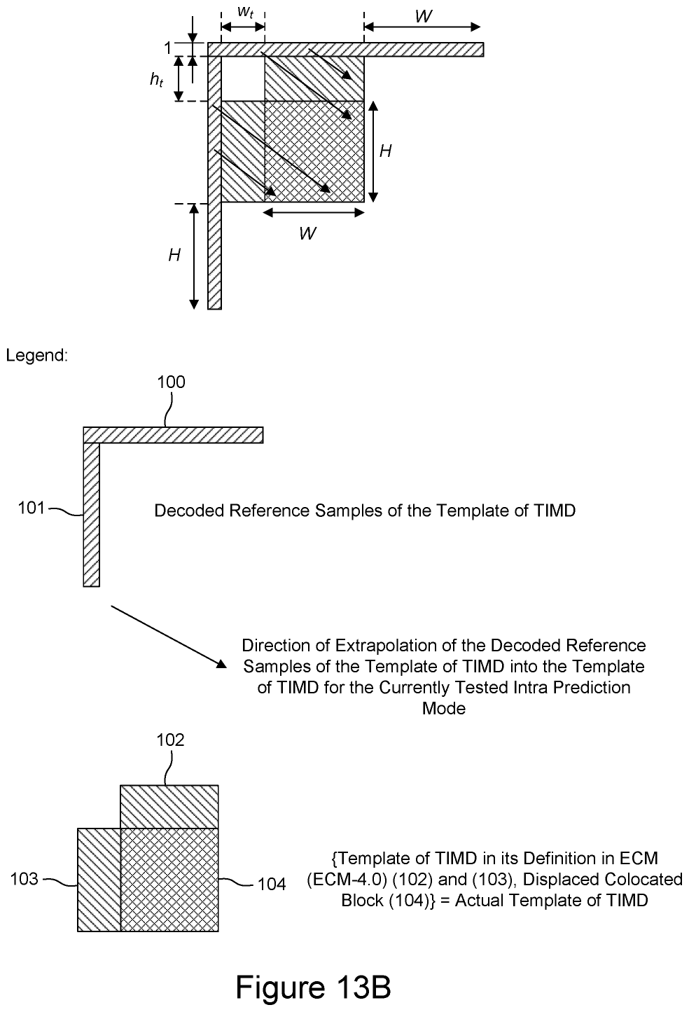

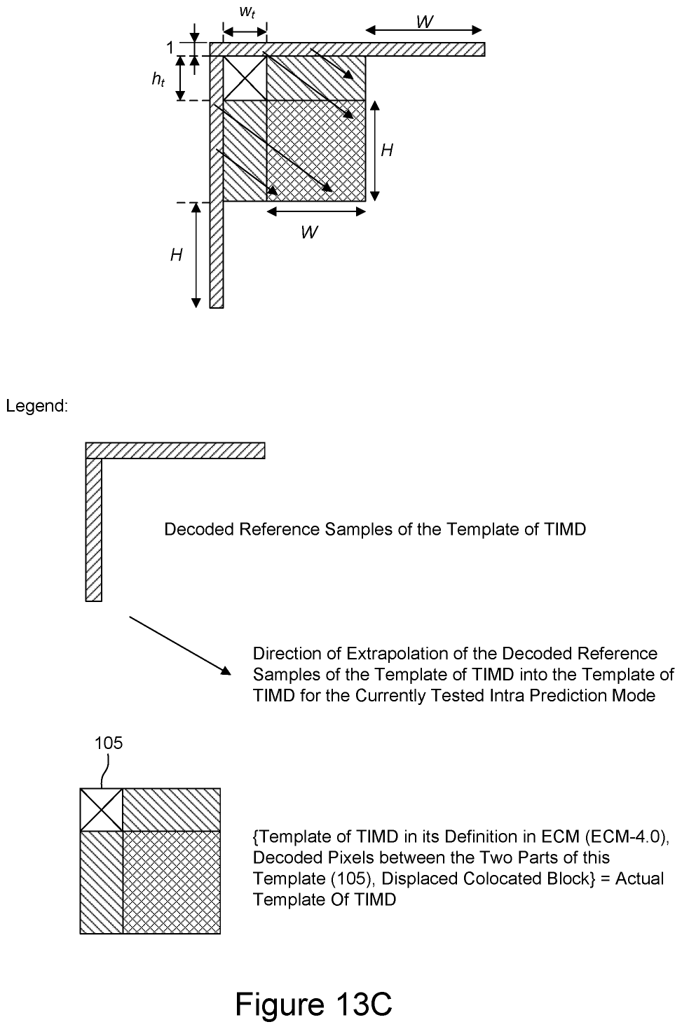

In a first embodiment, see FIG. 13(a), for the current CB in the current non-I slice, the decoded reference samples of this CB (98) correspond to the decoded reference samples of the template of TIMD. The displaced block from the reference frame to the position of the current CB (99) corresponds to the template of TIMD. Then, during the derivation of the two intra prediction modes via TIMD, for testing a given candidate intra prediction mode, the decoded reference samples of the template of TIMD are extrapolated into the template of TIMD following the candidate mode direction, yielding the prediction of the template of TIMD. For this mode, the prediction SATD between the mode prediction and the template of TIMD may be computed. After testing a given set of intra prediction modes, the two intra prediction modes yielding the two smallest prediction SATDs may be the two modes derived via TIMD.

In a second embodiment, see FIG. 13(b), for the current CB in the current non-I slice, the decoded reference samples of the template of TIMD follow the definition in ECM (ECM-4.0 at this point). In examples, let the current CB be of size W×H. Let h_t denote the height of the template and w_t denote the width of the template. Then, the decoded reference samples of the template of TIMD gathers the row of 2 W+w_t+1 decoded reference samples (100) and the column of 2H+h_t decoded reference samples (101). The template of TIMD following the definition in ECM (ECM-4.0 so far) (102) et (103) plus the displaced block from the reference frame to the position of the current CB (104) form the actual template of TIMD. Then, during the derivation of the two intra prediction modes via TIMD, for testing a given candidate intra prediction mode, the decoded reference samples of the template of TIMD are extrapolated into the template of TIMD following the candidate mode direction, providing the prediction of the template of TIMD. For this mode, the prediction SATD between the mode prediction and the template of TIMD may be computed.

In a third embodiment is shown in FIG. 13(c). The same configuration as in the second embodiment is used. However, the template of TIMD following the definition in ECM (ECM-4.0) plus the part between the two template portions (105) plus the displaced block from the reference frame to the position of the current CB form the actual template of TIMD.

### DIMD Process

In a variant, the DIMD process is applied to infer the intra mode of the displaced block. However, as samples inside the block are available, the inner part of the top left samples can be used to compute the modes.

### Simplified Process

In a variant, in order to decrease the complexity, a sub-sampled version of the prediction samples is constructed. For example, a sample every 2 samples horizontally and vertically are constructed and compared to the reconstructed block, reducing the complexity by a factor 4.

### Signaling

### Block Level

The table below shows an extract of the decoding of a coding unit, specifically the intra mode decoding. A flag is added at top of the intra syntax to signal the use of the temporal intra mode. In the example below, we assume that the temporal predictor used is inferred (for example using the global motion model) as well as the intra prediction mode (for example using TIMD to infer the intra mode).

### 7.3.11.5 Coding Unit Syntax

| | |
|---|---|
| if( CuPredMode[ chType ][ x0 ][ y0 ] = = MODE_INTRA \|\| | |
| CuPredMode[ chType ][ x0 ][ y0 ] = = MODE_PLT ) { | |
| if( treeType = = SINGLE_TREE \|\| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_temporal_intra_enabled_flag ) | |
| intra_temporal_flag | ae(v) |
| if( sps_mip_enabled_flag && !intra_temporal_flag) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else if (!intra_temporal_flag) { | |
| if( sps_mrl_enabled_flag && ( ( y0% CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |
| } | |
| } | |
| } | |

### Slice Level

At a slice/picture/sequence level, a flag signaled if the mode is used for example sps_intra_temporal_enabled_flag.
When at least one global motion model is used, the global motion model parameters are also transmitted, for example using the syntax below:

| | |
|---|---|
| sps_intra_temporal_enabled_flag | ae(v) |
| if (sps_intra_temporal_enabled_flag) { | |
| model_order | ae(v) |
| mvd_coding( cpmv_top_left ) | |
| if( model_order>1 ) | |
| mvd_coding( cpmv_top_right−cpmv_top_left ) | |
| if(model_order>2) | |
| mvd_coding( cpmv_bottom_left−cpmv_top_left ) | |
| if(model_order>3) | |
| mvd_coding( cpmv_bottom_right−(cpmv_top_right+cpmv_bottom_left)/2) | |

Syntax element model_order is an integer between 0 and 3 to control the order of the motion model (translational, affine 4, affine 6 or homographic).

In a variant the cpmv are coded differentially by predicting each corner using the already available corners and the associated model.

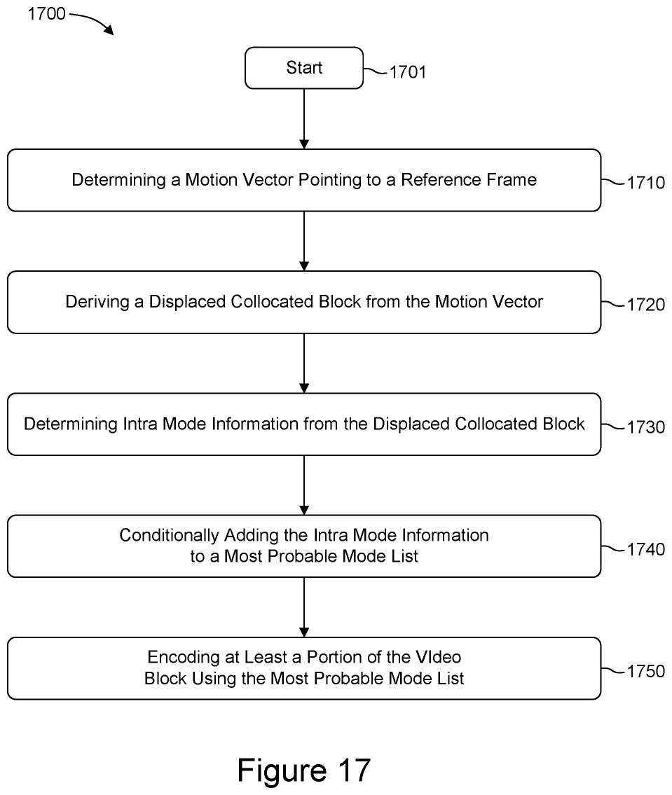

One embodiment of a method 1700 under the general aspects described here is shown in FIG. 17. The method commences at start block 1701 and control proceeds to block 1710 for determining a motion vector pointing to a reference frame for a video block. Control proceeds from block 1710 to block 1720 for deriving a displaced collocated block from the motion vector. Control proceeds from block 1720 to block 1730 for determining intra mode information from the displaced collocated block. Control proceeds from block 1730 to block 1740 for conditionally adding the intra mode information to a most probable mode list. Control proceeds from block 1740 to block 1750 for encoding at least a portion of the video block using the most probable mode list.

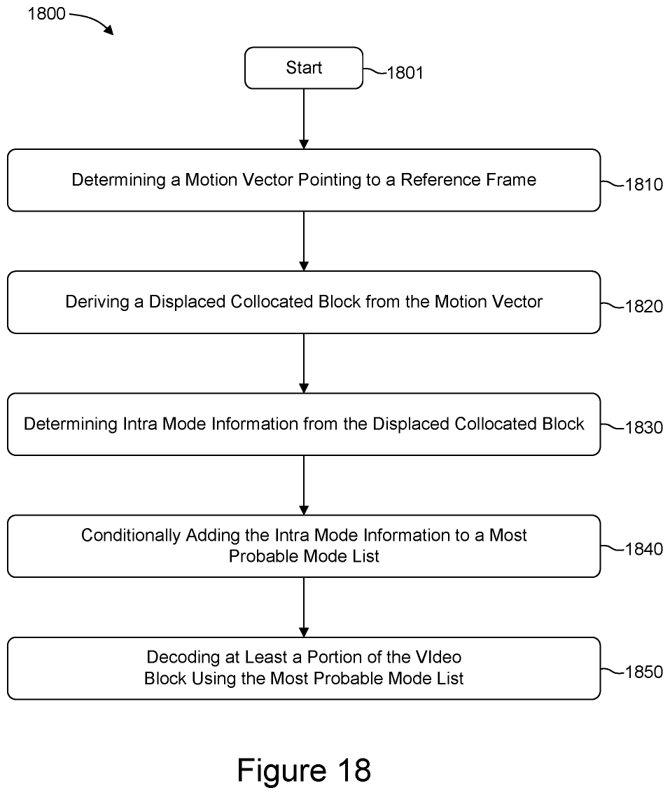

One embodiment of a method 1800 under the general aspects described here is shown in FIG. 18. The method commences at start block 1801 and control proceeds to block 1810 for determining a motion vector pointing to a reference frame for a video block. Control proceeds from block 1810 to block 1820 for deriving a displaced collocated block from the motion vector. Control proceeds from block 1820 to block 1830 for determining intra mode information from the displaced collocated block. Control proceeds from block 1830 to block 1840 for conditionally adding the intra mode information to a most probable mode list. Control proceeds from block 1840 to block 1850 for decoding at least a portion of the video block using the most probable mode list.

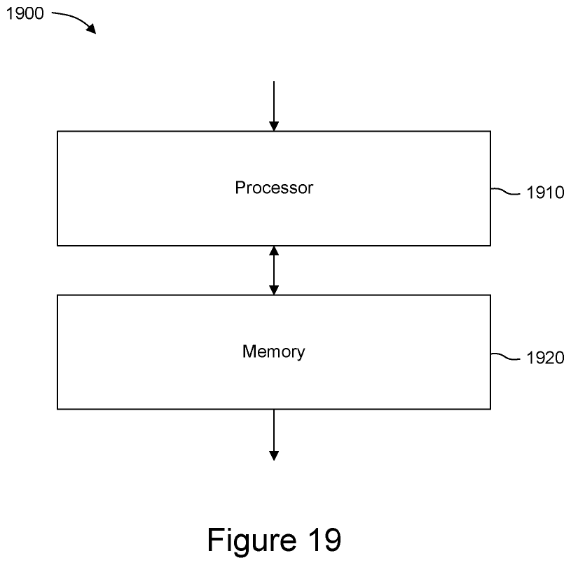

FIG. 19 shows one embodiment of an apparatus 1900 for encoding, decoding, compressing, or decompressing video data using any of the above methods, or variations. The apparatus comprises Processor 1910 and can be interconnected to a memory 1920 through at least one port. Both Processor 1910 and memory 1920 can also have one or more additional interconnections to external connections.

Processor 1910 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

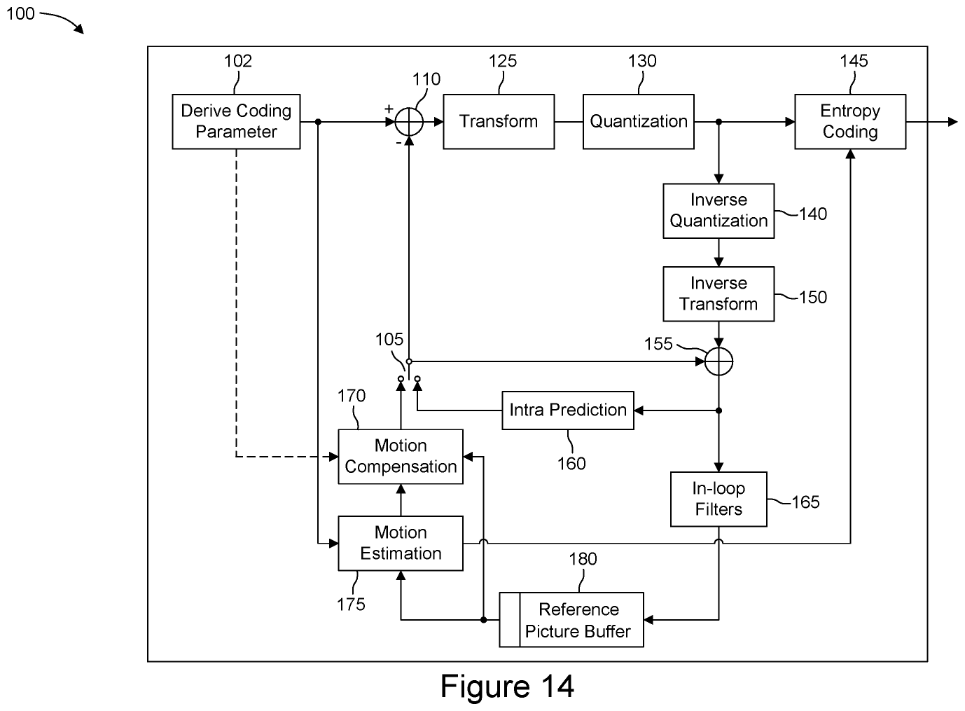

The aspects described and contemplated in this application can be implemented in many different forms. FIGS. 14, 15, and 16 provide some embodiments, but other embodiments are contemplated and the discussion of FIGS. 14, 15, and 16 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the intra prediction, entropy coding, and/or decoding modules (160, 360, 145, 330), of a video encoder 100 and decoder 200 as shown in FIG. 22 and FIG. 23. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 14 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (180).

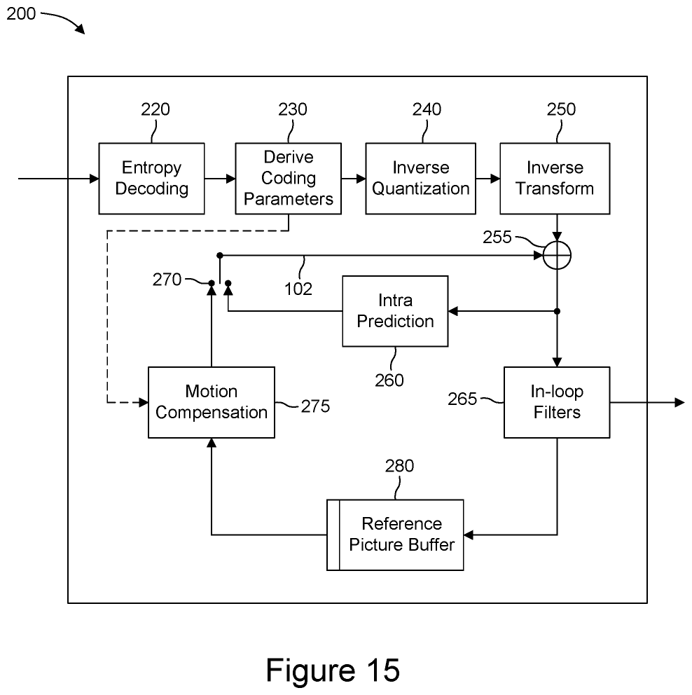

FIG. 15 illustrates a block diagram of a video decoder 200. In the decoder 200, a bitstream is decoded by the decoder elements as described below. Video decoder 200 generally performs a decoding pass reciprocal to the encoding pass as described in FIG. 14. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

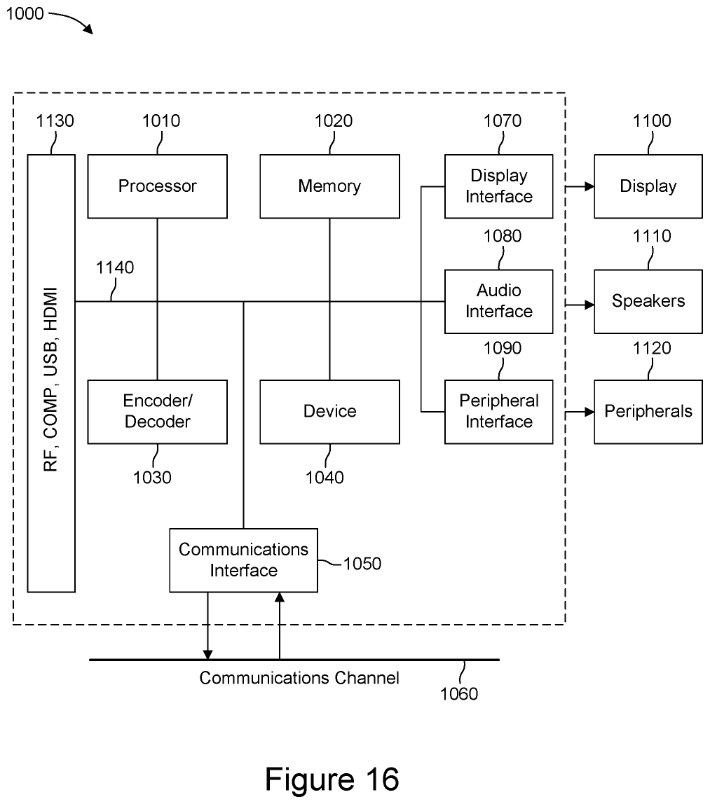

FIG. 16 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 16, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV. Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises determining an intra coding mode from a temporally collocated reference frame.

One embodiment comprises conditionally adding an intra coding mode to a most probable mode list, based on whether that mode already exists in the most probable mode list.

One embodiment comprises the above method wherein an intra coding mode is determined at an encoder and the mode and/or the reference frame is signaled to a corresponding decoder.

One embodiment comprises the above method wherein different motion models are used to determine a reference frame or a motion vector.

At least one embodiment comprises any of the above methods wherein an index is signaled to indicate a motion model, reference frame, or motion vector to be used for encoding/decoding.

At least one embodiment comprises a bitstream or signal that includes one or more syntax elements to perform the above functions, or variations thereof.

At least one embodiment comprises a bitstream or signal that includes syntax conveying information generated according to any of the embodiments described.

At least one embodiment comprises creating and/or transmitting and/or receiving and/or decoding according to any of the embodiments described.

At least one embodiment comprises a method, process, apparatus, medium storing instructions, medium storing data, or signal according to any of the embodiments described.

At least one embodiment comprises inserting in the signaling syntax elements that enable the decoder to determine decoding information in a manner corresponding to that used by an encoder.

At least one embodiment comprises creating and/or transmitting and/or receiving and/or decoding a bitstream or signal that includes one or more of the described syntax elements, or variations thereof.

At least one embodiment comprises a TV, set-top box, cell phone, tablet, or other electronic device that performs transform method(s) according to any of the embodiments described.

At least one embodiment comprises a TV, set-top box, cell phone, tablet, or other electronic device that performs transform method(s) determination according to any of the embodiments described, and that displays (e.g. using a monitor, screen, or other type of display) a resulting image.

At least one embodiment comprises a TV, set-top box, cell phone, tablet, or other electronic device that selects, bandlimits, or tunes (e.g. using a tuner) a channel to receive a signal including an encoded image, and performs transform method(s) according to any of the embodiments described.

At least one embodiment comprises a TV, set-top box, cell phone, tablet, or other electronic device that receives (e.g. using an antenna) a signal over the air that includes an encoded image, and performs transform method(s).

1. A method, comprising:
determining a motion vector pointing to a reference frame for a video block;
deriving a displaced collocated block from the motion vector;
determining intra mode information from the displaced collocated block;
conditionally adding the intra mode information to a most probable mode list; and
encoding at least a portion of the video block using the most probable mode list.

2. An apparatus, comprising:
a processor, configured to perform:
determining a motion vector pointing to a reference frame for a video block;
deriving a displaced collocated block from the motion vector;
determining intra mode information from the displaced collocated block;
conditionally adding the intra mode information to a most probable mode list; and
encoding at least a portion of the video block using the most probable mode list.

3. A method, comprising:
determining a motion vector pointing to a reference frame for a video block;
deriving a displaced collocated block from the motion vector;
determining intra mode information from the displaced collocated block;
conditionally adding the intra mode information to a most probable mode list; and
decoding at least a portion of the video block using the most probable mode list.

4. An apparatus, comprising:
a processor, configured to perform:
determining a motion vector pointing to a reference frame for a video block;
deriving a displaced collocated block from the motion vector;
determining intra mode information from the displaced collocated block;
conditionally adding the intra mode information to a most probable mode list; and
decoding at least a portion of the video block using the most probable mode list.

5. The method of claim 1, wherein said motion vector determination further comprises a motion model sent in a slice header.

6. The method of claim 1, wherein said motion vector determination is a motion model comprising one or more of an affine 4, an affine 6 or homographic model.

7. The method of claim 6, wherein motion of a current block is determined by a block from the motion model.

8. The apparatus of claim 4, wherein a conditional determination for adding the intra mode information to the most probable mode list comprises a cost.

9. The apparatus of claim 4, wherein motion information is obtained using an intercoded process, wherein a candidate from an intercoded merge list is used.

10. The apparatus of claim 4, wherein a template-based re-ordering is used to select a most probable candidate in the most probable mode list.

11. The of apparatus of claim 4, wherein a collocated reference frame to use, or an index to a reference frame to use, is signaled.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of the video block.

13. A non-transitory computer readable medium containing data content generated according to the method of claim 1, for playback using a processor.

14. (canceled)

15. A computer program product comprising instructions which, when the program is executed by a computer, cause the computer to carry out the method of any of claim 1.

16. The method of claim 3, wherein said motion vector determination further comprises a motion model sent in a slice header.

17. The method of claim 3, wherein said motion vector determination is a motion model comprising one or more of an affine 4, an affine 6 or homographic model.

18. The method of claim 17, wherein motion of a current block is determined by a block from the motion model.

19. The apparatus of claim 4, wherein a conditional determination for adding the intra mode information to the most probable mode list comprises a cost.

20. The apparatus of claim 4, wherein motion information is obtained using an intercoded process, wherein a candidate from an intercoded merge list is used.

21. The apparatus of claim 4, wherein a template-based re-ordering is used to select a most probable candidate in the most probable mode list.
